(19) United States
(12) Patent Application Publication
(10) Pub. No.: US 2026/0275918 A1
(43) Pub. Date: Sep. 17, 2026

(54) ASSEMBLY FOR A MECHANICAL REDUCER OF AN AIRCRAFT

(71) Applicant: SAFRAN TRANSMISSION SYSTEMS, Colombes (FR)

(72) Inventors: Loic FRANCOIS, Moissy-Cramayel (FR); Maxime FERNANDEZ, Moissy-Cramayel (FR); Boris Pierre Marcel MORELLI, Moissy-Cramayel (FR); Jordane Emile Andre PELTIER, Moissy-Cramayel (FR); Antoine Jacques Marie PENNACINO, Moissy-Cramayel (FR)

(21) Appl. No.: 19/470,652

(22) PCT Filed: Apr. 4, 2024
(86) PCT No.: PCT/FR2024/050439

§ 371 Date: Sep. 29, 2025

(30) Foreign Application Priority Data
Apr. 6, 2023 (FR) FR2303454

(51) Int. Cl. F02C 7/32; B64C 25/32; F16H 57/04

(52) U.S. Cl. CPC F02C 7/32; F16H 57/0428; F16H 57/0457; F16H 57/0486; B64C 25/405; F05D 2260/40311; F05D 2260/98

(57) ABSTRACT

An assembly, including planet gears and a planet carrier, for a splash-lubricated mechanical reducer, in particular of an aircraft, this assembly having an annular shape about a longitudinal axis, the planet carrier having an annular shape about the axis and comprising-including recesses for receiving the planet gears that are delimited by two lateral partitions, wherein the assembly further includes oil scoops which are rigidly connected to the planet carrier and which are regularly distributed about the axis and positioned between the planet gears, each of these scoops including at least one curved cup, the concavity of which extends partly around one of the planet gears and is separated from this planet gear by one of the partitions.

### TECHNICAL FIELD OF THE INVENTION

The present invention relates to an assembly for a mechanical reducer of an aircraft, and in particular for an aircraft turbomachine or for a drive system for driving a wheel of an aircraft landing gear. This assembly comprises planet gears and a planet carrier.

### TECHNICAL BACKGROUND

The prior art comprises in particular the documents FR-A1-3 025 780, FR-B1-3 066 792, FR-B1-3 071 023, FR-3 072 749, FR-B1-3 098 562, FR-B1-3 101 129, and U.S. Pat. No. 5,669,844.

The role of a mechanical reducer is to modify the speed and torque ratio between the input axle and the output axle of a mechanical system.

The new generations of double flow turbomachines, in particular those with a high bypass ratio, comprise a mechanical reducer to drive the shaft of a fan. The usual purpose of the reducer is to convert the rotational speed referred to as high speed of the shaft of a power turbine into a slower rotational speed for the shaft driving the fan.

A drive system for driving a landing gear wheel may also comprise a mechanical reducer, as proposed by the Applicant in the document EP-A1-3 882 136.

Such a reducer comprises a central pinion, referred to as sun gear, a ring gear and pinions referred to as planet gears, which are engaged between the sun gear and the ring gear. The planet gears are maintained by a frame referred to as planet carrier. The sun gear, the ring gear and the planet carrier are planetary gears because their axes of revolution coincide with the axis of the turbomachine or of a wheel of a landing gear. The planet gears each have a different axis of revolution equally distributed on the same operating diameter around the axis of the planetary gears. These axes are parallel to the longitudinal axis X.

There are several reducer architectures. In the prior art, the reducers are of the planetary or epicyclic type. In other similar applications, there are architectures referred to as differential or “compound”.
In a planetary reducer, the planet carrier is stationary and the ring gear is the output shaft of the device which rotates in the opposite orientation of the sun gear.
In an epicyclic reducer, the ring gear is stationary and the planet carrier is the output shaft of the device which rotates in the same orientation as the sun gear.
On a compound reducer, no element is attached in rotation. The ring gear rotates in the opposite orientation of the sun gear and of the planet carrier.

The reducers may consist of one or more meshing stages. This meshing is ensured in different ways such as by contact, friction or magnetic field. There are several types of contact meshing such as straight, helical or herringbone toothings.

The reducers may consist of one or more meshing stages. This meshing is ensured in different ways such as by contact, friction or magnetic field.

A planet gear may comprise one or two meshing stages. In the present application, “stage” or “toothing” means a series of gearing teeth with a series of complementary teeth. A toothing may be internal or external. A single-stage planet gear comprises a toothing that may be straight, helical or herringbone, and whose teeth are located on a same diameter. This toothing cooperates with both the sun gear and the ring gear.

A double-stage planet gear comprises two toothings or two series of teeth that are located on different diameters. A first toothing cooperates with the sun gear and a second toothing cooperates with the ring gear.

There is also a configuration, referred to as Wolfrom, wherein the planet gears are double-stage and comprise a first toothing that cooperates with the sun gear and a ring gear, and a second toothing that cooperates with a second ring gear. The reducer thus comprises two ring gears, one of which is stationary and the other movable.

A mechanical reducer needs to be lubricated to ensure it works properly and to dissipate the heat generated during operation. Lubricating oil is used for this.

There are two lubrication technologies for a mechanical reducer.

The first technology consists of lubricating the reducer with oil jets. The jets are oil-fed and spray oil onto the gears, i.e. the toothings of the sun gear, the planet gears and the ring gear or ring gears. This oil is then removed and recovered for recycling.

Another technology consists of using an oil splash-lubricated reducer. The oil is permanently present in the reducer, which comprises a sealed enclosure for retaining this oil. The oil level in the enclosure of the reducer is such that at least some of the planet gears, the planet carrier and the ring gear or ring gears are splashing in the oil, i.e. are permanently bathed in oil.

In a splash-lubricated reducer, gravity causes the oil to flow and be stored in the bottom portion of the enclosure and of the reducer. This means that the toothing located at the bottom portion are immersed in oil, whereas the toothing at the top portion are not. During operation, the rotating elements contained in the enclosure rotate at high speeds and entrain the oil. The oil tends to centrifuge and form an oil ring inside the enclosure.

One of the problems of a mechanical splash-lubricated reducer is to ensure that all its gears are well lubricated.

The invention provides a simple, effective and economical solution to this problem.

### SUMMARY OF THE INVENTION

The invention relates to an assembly comprising planet gears and a planet carrier for a mechanical splash-lubricated reducer, in particular for an aircraft, this assembly having an annular shape about a longitudinal axis,
the planet gears being evenly spaced around said axis and each comprising two cylindrical longitudinal ends,
the planet carrier having an annular shape about said axis and comprising housings for receiving the planet gears, these housings being evenly distributed about said axis and each being axially delimited by two walls extending respectively in two planes perpendicular to said axis, and two lateral bulkheads extending between the walls, these walls comprising orifices for mounting said longitudinal ends of the planet gears,
characterized in that it further comprises oil scoops which are secured to the planet carrier and which are evenly distributed around said axis and interposed between the planet gears, each of these scoops comprising at least one curved bucket, the concavity of which extends partly around one of the planet gears and is separated from this planet gear by one of said bulkheads.

As mentioned above, during operation, a ring of oil forms around the reducer in its enclosure. The invention allows to force the oil to move and, for example, redirect it towards gears to be lubricated in the reducer. To achieve this, the assembly formed by the planet gears and the planet carrier comprises oil scoops.

The solution proposed below is compatible with a single-stage or multi-stage reducer. It may be fitted with an epicyclic, differential or Wolfrom reducer. It is also compatible with straight, helical or herringbone toothings. It is compatible with all types of planet carrier, and in particular with a single part planet carrier. It is also compatible with any type of bearing, whether made up of rolling elements, a hydrodynamic bearing, etc. It is compatible with a use of the assembly and the reducer in a double flow turbomachine, for example to drive a fan or a propeller. It is also compatible with the use of the assembly and of the reducer in a drive system for driving a wheel of a landing gear.

The assembly according to the invention may comprise one or more of the following characteristics, taken alone from each other, or in combination with each other:
each of the scoops comprises two curved buckets whose concavities are oriented in opposite directions to extend respectively around the planet gears between which the scoop is mounted,
the two buckets of each of the scoops are connected to each other by a plate for attachment to the planet carrier,
each of the scoops is formed in one-part,
the bucket and the planet gear, around which the concavity of the bucket extends, are located at a circumferential distance from each other which is greater than or equal to half a maximum radius of the planet gear,
the or each bucket has an axial dimension which is less than an axial dimension of said bulkheads,
Dext_CI≤Dext_Go≤Dext_Sa, and Dint_Sa≤Dint_Go≤Dint_CI,
wherein:
Dext_CI is the diameter of a circumference centered on said axis and passing through radially external ends of said bulkheads,
Dext_Go is the diameter of a circumference centered on said axis and passing through radially external ends of said buckets,
Dext_Sa is the maximum diameter of a circumference centered on said axis and passing through the planet gears,
Dint_Sa is the minimum diameter of a circumference centered on said axis and passing through the planet gears,
Dint_Go is the diameter of a circumference centered on said axis and passing through radially internal ends of said buckets, and
Dint_CI is the diameter of a circumference centered on said axis and passing through radially internal ends of said bulkheads.
each of the scoops is attached by screws or bolts to the planet carrier, these screws or bolts also being used to attach two rings of the planet carrier respectively forming said walls of said housings; alternatively, each of the scoops is welded to the planet carrier,
said walls comprise first walls joined together to form a first ring of the planet carrier, this first ring extending substantially in a plane perpendicular to said longitudinal axis,
said walls comprise second walls which are circumferentially spaced from each other and which are joined by material bridges to form a second ring of the planet carrier, the second walls extending substantially in a plane perpendicular to said longitudinal axis, and said material bridges extending out of that plane,
the scoops are formed in one-part with the planet carrier or a portion of the planet carrier;
said bulkheads are formed in one-part with one of the walls of the planet carrier.

The present invention also relates to a mechanical splash-lubricated reducer, in particular for an aircraft, this reducer comprising:
a sun gear which is movable in rotation about a longitudinal axis,
at least one ring gear mounted around the sun gear and said longitudinal axis, and
an assembly as described above which is movable in rotation about said longitudinal axis, the planet gears of said assembly being mounted between the sun gear and the ring gear or ring gears and meshed with the sun gear and the ring gear, said planet gears having axes of rotation parallel to said axis, and
a sealed enclosure wherein the sun gear, the first ring gear and said assembly are located, this enclosure being configured to contain oil intended to be scooped by the oil scoops of said assembly.

According to one embodiment of the invention, the planet gears are double-stage and comprise a first stage meshed with a first ring gear which is movable about said longitudinal axis and the sun gear, and a second stage meshed with a second ring gear which is stationary relative to said longitudinal axis.

Advantageously, the or each bucket of each of the scoops is axially offset from the ring gear in order to scoop oil next to the ring gear, or is axially offset from the stationary ring gear and radially aligned with the mobile ring gear in order to scoop oil at the level of this mobile ring gear, or is axially offset from the mobile ring gear and radially aligned with the stationary ring gear in order to scoop oil at the level of this stationary ring gear.

The invention also relates to a turbomachine or a drive system for driving a landing gear wheel, in particular of an aircraft, comprising at least one assembly or a mechanical reducer as described above.

### BRIEF DESCRIPTION OF THE FIGURES

Further characteristics and advantages will be apparent from the following description of a non-limiting embodiment of the invention with reference to the appended drawings wherein:

FIG. 1 is a schematic view of an aircraft turbomachine in axial cross-section,

FIG. 2 is a partial schematic view of a planetary mechanical reducer with oil jets in axial cross-section,

FIG. 3 is a schematic view of a splash-lubricated planetary mechanical reducer in axial cross-section,

FIG. 4 is a partial schematic view of a Wolfrom splash-lubricated reducer in axial cross-section,

FIG. 5 is a schematic front view of an assembly according to one embodiment of the invention, for a mechanical splash-lubricated reducer,

FIG. 6 is a larger-scale schematic view of a portion of the assembly shown in FIG. 5, and illustrates the operation of the reducer and the rotation of the assembly,

FIG. 7 is another larger-scale schematic view of a portion of the assembly shown in FIG. 5, and illustrates the operation of the reducer and the rotation of the assembly,

FIG. 8 is a partial schematic perspective view of a reducer comprising a variant of embodiment of an assembly according to the invention,

FIG. 9 is a partial schematic perspective view of a reducer comprising another variant of embodiment of an assembly according to the invention,

FIG. 10 is a schematic perspective view of a wheel of an aircraft landing gear and a drive system for driving this wheel.

### DETAILED DESCRIPTION OF THE INVENTION

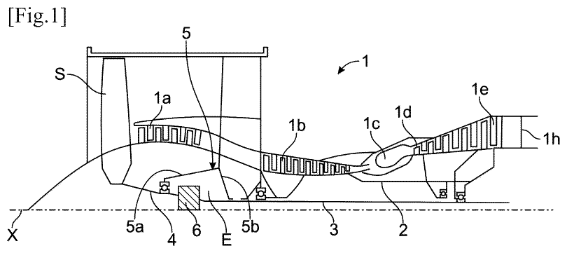

FIG. 1 describes a turbomachine 1 which conventionally comprises a fan S, a low-pressure compressor 1a, a high-pressure compressor 1b, an annular combustion chamber 1c, a high-pressure turbine 1d, a low-pressure turbine 1e and an exhaust nozzle 1h. The high-pressure compressor 1b and the high-pressure turbine 1d are connected by a high-pressure shaft 2 and together they form a high-pressure (HP) body. The low-pressure compressor 1a and the low-pressure turbine 1e are connected by a low-pressure shaft 3 and together they form a low-pressure (BP) body.

The fan S is driven by a fan shaft 4 which is driven in rotation with the shaft BP 3 by means of a reducer 6. This reducer 6 may be of the planetary, epicycloidal or Wolfrom type, for example.

Although the following description concerns a reducer of the planetary or epicyclic type, it also applies to a mechanical differential wherein the three elements, namely the planet carrier, the ring gear and the sun gear, may be movable in rotation, the rotational speed of one of these elements depending in particular on the difference in speed of the other two elements. It also applies to the special case of a Wolfrom-type double-stage reducer.

The reducer 6 is positioned in the upstream portion of the turbomachine. A stationary structure comprising schematically, here, an upstream portion 5a and a downstream portion 5b which makes up the engine casing or stator 5 is arranged so as to form an enclosure E surrounding the reducer 6. This enclosure E is here closed upstream by gaskets at the level of a bearing allowing the passage of the fan shaft 4, and downstream by gaskets at the level of the passage of the shaft BP 3.

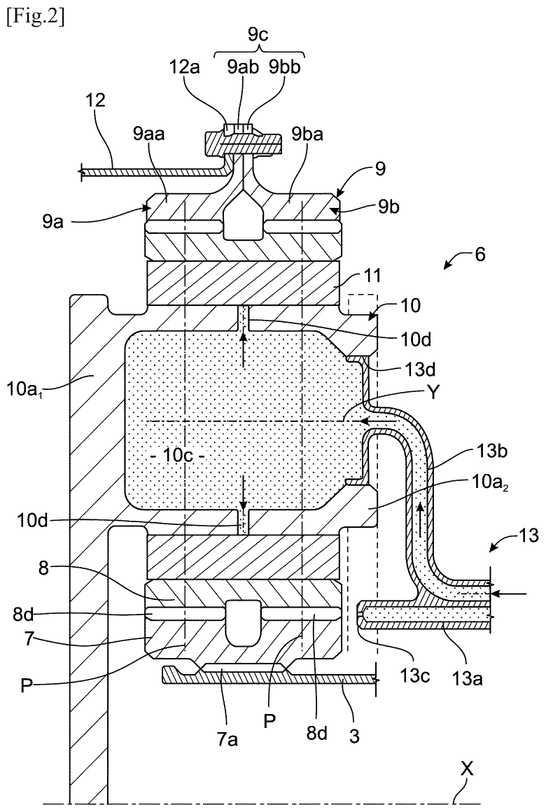

FIG. 2 shows a reducer 6 which may take the form of different architectures depending on whether certain parts are stationary or in rotation. The input of the reducer 6 is connected to the shaft BP 3, for example by means of internal splines 7a. Thus the shaft BP 3 drives a planetary pinion referred to as the sun gear 7. Typically, the sun gear 7, whose axis of rotation coincides with that of the turbomachine X, drives a series of pinions referred to as planet gears 8, which are distributed over the same diameter around the axis of rotation X. This diameter is equal to twice the operating center distance between the sun gear 7 and the planet gears 8. The number of planet gears 8 is generally defined between three and seven for this type of application.

The assembly of the planet gears 8 are held by a planet carrier 10. Each planet gear 8 rotates around its own axis Y, and meshes with the ring gear 9.

In the output we have:
in an epicyclic configuration, the assembly of the planet gears 8 drives the planet carrier 10 in rotation around the axis X of the turbomachine. The ring gear is attached to the engine casing or stator 5 via a ring gear carrier 12 and the planet carrier 10 is attached to the shaft of the fan 4.
in a planetary configuration, the assembly of the planet gears 8 is maintained by a planet carrier 10 which is attached to the engine casing or stator 5. Each planet gear drives the ring gear which is fitted to the fan shaft 4 via a ring gear carrier 12.

Each planet gear 8 is mounted so that it may rotate freely by means of a bearing 11, for example a hydrodynamic rolling bearing or plain bearing. In the case of a plain bearing, the bearing 11 comprises a bearing body 10b and the bearing bodies 10b of the various plain bearings are positioned relative to one another and are carried by walls 10a1, 10a2 of the planet carrier 10.

The walls 10a1, 10a2 are annular and perpendicular to the axis X. They are axially spaced apart and receive between them the bearings 11, the planet gears 8 and the sun gear 7.

The number of bearings 11 is equal to the number of planet gears 8. For reasons of operation, assembly, manufacture, inspection, repair or replacement, the bearings 11 (and in particular the bearing bodies 10b) and the walls 10a1, 10a2 may be separated into several parts.

For the same reasons mentioned above, the toothing 8d of a reducer may be separated into several propellers each with a median plane P. In our example, we detail the operation of a reducer with several propellers with one ring gear separated into two half-ring gears:
an upstream half-ring gear 9a consisting of a rim 9aa and an attachment half-flange 9ab. On the rim 9aa there is the upstream propeller of the toothing of the reducer. This upstream propeller meshes with that of the planet gear 8 which meshes with that of the sun gear 7.
a downstream half-ring gear 9b consisting of a rim 9ba and an attachment half-flange 9bb. On the rim 9ba is the downstream propeller of the toothing of the reducer. This downstream propeller meshes with that of the planet gear 8 which meshes with that of the sun gear 7.

If the propeller widths vary between the sun gear 7, the planet gears 8 and the ring gear 9 because of the toothing overlaps, they are all centered on a median plane P for the upstream propellers and on another median plane P for the downstream propellers.

The attachment half-flange 9ab of the upstream ring gear 9a and the attachment half-flange 9bb of the downstream ring gear 9b form the attachment flange 9c of the ring gear. The ring gear 9 is attached to a ring gear carrier by assembling the attachment flange 9c of the ring gear and the attachment flange 12a of the ring gear carrier by means of a bolted mounting, for example.

Alternatively, the flange 9c of the ring gear 9 may be replaced by splines.

The arrows in FIG. 2 describe the conveying of the oil in the reducer 6. The oil arrives in the reducer 6 from the stator portion 5 in the turbine stator 13 by different means which will not be specified in this view because they are specific to one or several types of architecture. The turbine stator is divided into two portions, each of which is generally made up of the same number of planet gears. The function of the injectors 13a is to lubricate the toothings and the function of the arms 13b is to lubricate the bearings 11. The oil is fed towards injectors 13a and emerges through ends 13c so as to lubricate the toothings of the planet gears 8, the sun gear 7 and also the ring gear 9 with oil. The oil is also fed towards the arm 13b and circulates via the supply mouth 13d of the bearing body 10b into an internal cavity 10c of the latter. The oil then circulates in this cavity 10c to supply oil passage orifices 10d up to an external cylindrical surface for guiding the corresponding planet gear.

The reducer 6 shown in FIG. 2 is therefore a reducer of the nozzle or oil injector type.

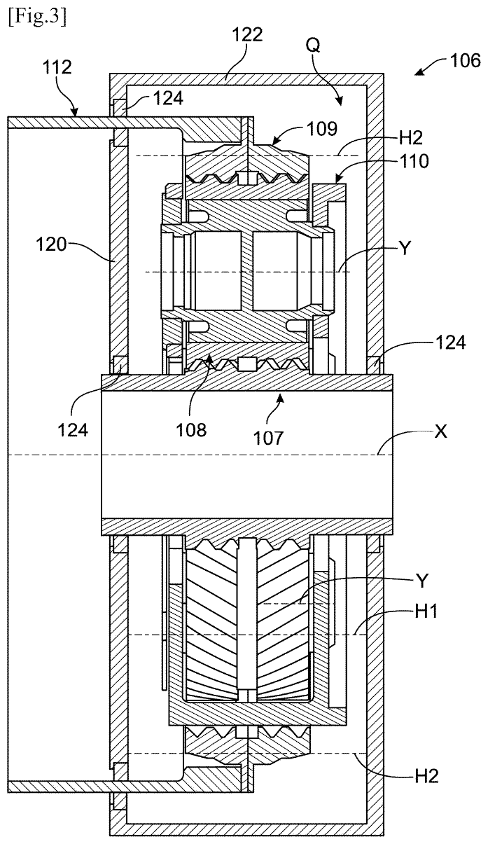

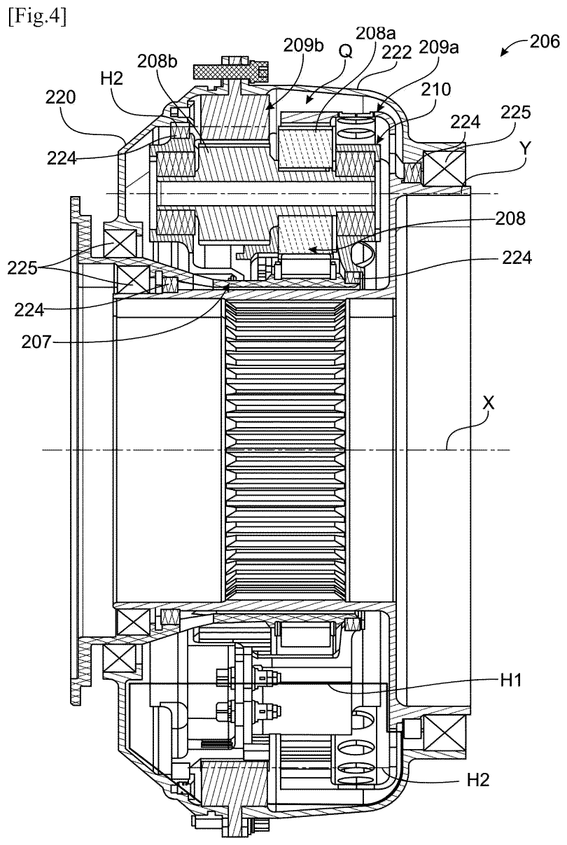

On the other hand, the present invention relates to a reducer of the splash-lubricated type, two examples of which are illustrated in FIGS. 3 and 4.

In FIG. 3, the reducer 106 is a planetary splash-lubricated reducer, i.e. its ring gear 109 is mobile and its planet carrier 110 is stationary, or an epicyclic splash-lubricated reducer, i.e. its ring gear is stationary and its planet carrier is mobile. As may be seen in this figure, the reducer 106 is enclosed in a sealed enclosure Q.

The enclosure Q may be formed by one or more annular casings 120, 122 assembled together. The sealing is ensured by gaskets 124 or similar which are located, for example:
between the casing 120, 122 of the enclosure Q and the sun gear 107 or the shaft secured to the sun gear or coupled with the sun gear,
between the ring gear 109 or the ring gear carrier 112 and the casing 120, 122 of the enclosure Q.

At standstill, the oil H1 contained in the enclosure Q is located in the bottom portion of the reducer 106 and in particular of the enclosure Q. A portion of the ring gear 109, the planet gears 108 and the planet carrier 110 are bathed or splashed in this oil. During operation, a ring of oil H2 forms inside the enclosure Q, all around the axis X.

In FIG. 4, the reducer 206 is a splash-lubricated Wolfrom reducer, i.e. it comprises two ring gears 209a, 209b, namely a moving ring gear 209a and a stationary ring gear 209b. As may be seen in this figure, the reducer 206 is also enclosed in a sealed enclosure Q.

The planet gears 208 are double-stage and comprise a first stage 208a meshed with the first ring gear 209a and the sun gear 207, and a second stage 208b meshed with a second ring gear 209b which is stationary relative to said longitudinal axis X.

The enclosure Q may be formed by one or more annular casings 220, 222 assembled together. The stationary ring gear 209b is attached to the casing or casings 220, 222 of the enclosure Q, and in particular is interposed between two casings 220, 222 of the enclosure Q.

The sealing is ensured by annular gaskets 225 or similar which are located, for example:
between the casing 220, 222 of the enclosure Q and the sun gear 207 or the shaft secured to the sun gear or coupled with the sun gear,
between the casing 220, 222 of the enclosure Q and the mobile ring gear 209a, and
between the mobile ring gear 209a and the sun gear 207 or the shaft secured to the sun gear or coupled with the sun gear.

There may also be seals between the planet carrier 210 and the sun gear 207 or the shaft secured to the sun gear or coupled with the sun gear, as well as between this sun gear 207 or this shaft and the mobile ring gear 209a or the element secured in rotation to the mobile ring gear.

The elements movable in rotation are guided by rolling bearings 224 which are located, for example:
between the casing 220, 222 of the enclosure Q and the moving ring gear 209a,
between the casing 220, 222 of the enclosure and the planet carrier 210,
between the planet carrier 20 and the planet gears 208, and
between the mobile ring gear 209a and the sun gear 207 or the shaft secured to the sun gear or coupled with the sun gear.

At standstill, the oil H1 is located in the bottom portion of the reducer 206 and in particular the enclosure Q. Some of the ring gears 209a, 209b, the planet gears 208 and the planet carrier 210 are bathed or splashed in this oil. During operation, a ring of oil H2 forms inside the enclosure Q, all around the axis X.

The present invention relates to an assembly 230 for an aircraft mechanical reducer 106, 206, said assembly 230 comprising planet gears 232 and a planet carrier 234. This assembly 230 is movable in rotation about the axis X, so the reducer 106, 206 may be of the epicycloidal, differential or Wolfrom type. This reducer 106, 206 may also be used in a turbomachine 1 such as that shown in FIG. 1, to drive a fan S, or in another context such as in a drive system for driving a wheel for an aircraft landing gear (see FIG. 10).

The assembly 230 according to the invention may cooperate with a single ring gear 109 as in the case of the reducer 106 in FIG. 3, or with two separate ring gears, respectively mobile 209a and stationary 209b, as in the reducer 206 in FIG. 4.

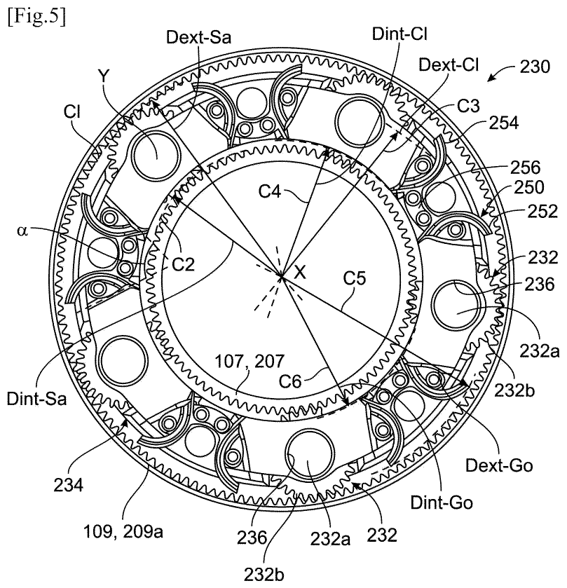

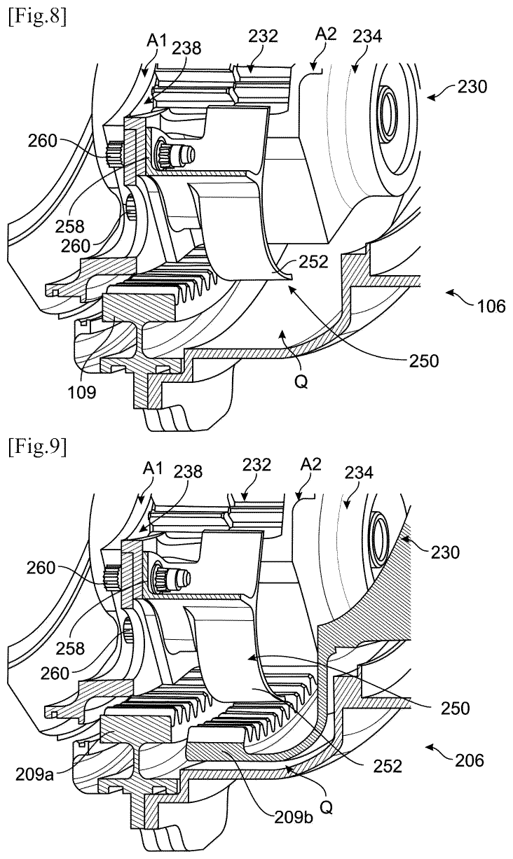

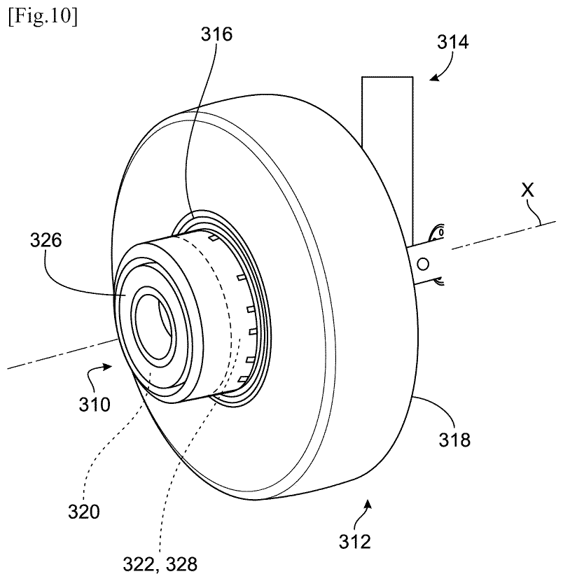

FIGS. 5 to 7 illustrate a first embodiment of an assembly 230 according to the invention, and FIGS. 8 and 9 illustrate alternative embodiments of this assembly 230.

The planet gears 232 are evenly spaced around the axis X and each comprise two cylindrical longitudinal ends 232a, as may also be seen in FIGS. 3 and 4. Each of the planet gears 232 may comprise a single toothing 232b configured to mesh with the sun gear 107 and the ring gear 109. Alternatively, each of the planet gears 232 may comprise two toothings 232b, one of which is meshed with the sun gear 207 and the mobile ring gear 209a and the other of which is meshed with the stationary ring gear 209b.

In a manner known per se, the or each toothing 232b of each planet gear 232 may be formed in one-part with a physical axis centered on the axis Y and comprising the two longitudinal ends 232a. This is the case, for example, of one of the toothing of the planet gears 208 in FIG. 4 (the one on the left), which is formed in one-part with both longitudinal ends. Alternatively, the or each toothing 232b of each planet gear 232 may be shrunk onto a physical axle comprising these longitudinal ends 232a. This is the case, for example, with the other of the toothings of the planet gears 208 in FIG. 4 (the right-hand one) and the toothing of the planet gears 108 in FIG. 3, which are each mounted by a plain bearing on a physical body comprising two longitudinal ends 232a for mounting on the planet carrier. Note:
Dext_Sa, the maximum diameter of a circumference C1 centered on the axis X and passing through the planet gears 232, and
Dint_Sa, the minimum diameter of a circumference C2 centered on the axis X and passing through the planet gears 232.

The planet carrier 234 is annular about the axis X and comprises housings 238 for receiving the planet gears 232. These housings 238 are evenly distributed around the axis X and are each axially delimited by two walls 240, 242 extending respectively in two planes perpendicular to the axis X, and two lateral bulkheads 244 extending between the walls 240,242.

The walls 240, 242 comprises orifices 236 for mounting the longitudinal ends 232a of the planet gears 232.

The walls 240, 242 defining the housings 238 comprise first walls 240 connected to each other to form a first ring A1 around the axis. This first ring A1 extends mainly in a plane perpendicular to the axis X.

The second walls 242 are at a circumferential distance from each other, and are connected to each other by material bridges 243 to form a second ring A2 about the axis X. These material bridges 243 are configured to be applied and attached to the first ring A1 to secure the two rings A1, A2 of the planet carrier 234 together. The second walls 242 thus define free circumferential spaces E between them.

Each of the second walls 242 is connected to the bulkheads 244 by its circumferential ends. The aforementioned spaces E are thus delimited in the circumferential direction by these bulkheads 244.

The bulkheads 244 may diverge radially outwards from one another, as in the example shown. For example, they form an angle a greater than or equal to 60°, measured in a plane perpendicular to the axis X (FIG. 5). Alternatively, this angle a may be less than 60° or even negative, as required.

Note:
Dext_CI, the diameter of a circumference C3 centered on the axis X and passing through the radially external ends of the bulkheads 244, and
Dint_CI, the diameter of a circumference C4 centered on the axis X and passing through the radially internal ends of the bulkheads 244.

FIG. 1 shows that:
Dext_CI<Dext_Sa, et
Dint_CI>Dint_Sa.

The assembly 230 according to the invention also comprises oil scoops 250 which are secured to the planet carrier 234 and which are evenly distributed around the axis X and interposed between the planet gears 232.

Each of the scoops 250 comprises at least one curved bucket 252, 254, the concavity 256 of which extends partly around one of the planet gears 232 and is separated from this planet gear by one of the bulkheads 244.

In a reducer with oil jets such as the one shown in FIG. 2, oil collectors may be inserted between the planet gears. These collectors have concavities that surround the planet gears, as close as possible to their toothings, and the function of these collectors is to collect the oil sprayed by the toothings and to guide its flow.

In the present invention, the scoops 250 do not have the same function because they are separated by the bulkheads 244 from the toothings 232b of the planet gears 232, and are also at a distance from these toothings.

It is thus understood that the scoops 250 are housed in the aforementioned spaces E.

Each of the scoops 250 may comprise a single bucket 252 whose concavity 256 is oriented according to the direction of rotation of the planet carrier 234, as will be described in more detail below.

In the example shown, each of the scoops 250 comprises two curved buckets 252, 254 whose concavities 256 are oriented in opposite directions to extend respectively around the planet gears 232 between which the scoop 250 is mounted.

The two buckets 252, 254 of each scoop 250 may be connected to each other by a plate 258 for attachment to the planet carrier 234. This plate 258 extends, for example, in a plane perpendicular to the axis X and is applied axially against the planet carrier 234, and in particular against the first ring A1 formed by the first walls 240.

The plate 258 comprises axial orifices which are aligned with orifices in the planet carrier 234 for the passage of attachment means (not shown) of the screw-nut type or similar.

Alternatively, the plate 258 may be attached to the planet carrier by welding. In this case, the plate 258 does not comprise any orifices for its attachment.

These attachment means may also be used to attach the two rings A1, A2 of the planet carrier 234. The orifices in the plate 258 are then aligned with the orifices in the two rings A1, A2 of the planet carrier 234.

Each of the scoops 250 may be formed in one-part, as in the example shown. The bucket or buckets 252, 254 and the plate 258 are thus formed in one-part.

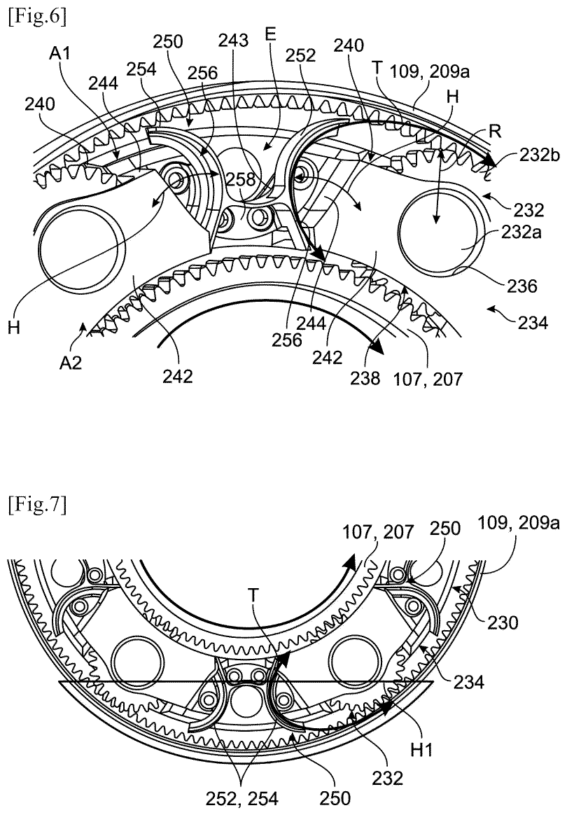

The bucket 252, 254 and the planet gear 232, around which the concavity 256 of the bucket extends, are located at a circumferential distance H from each other which is, for example, greater than or equal to half the maximum radius R of the planet gear 232 (FIG. 6).

The or each bucket 252, 254 has an axial dimension L1 which is smaller than an axial dimension L2 of the bulkheads 244.

Note:
Dext_Go, the diameter of a circumference C5 centered on the axis X and passing through the radially external ends of the buckets 252, 254,
Dint_Go, the diameter of a circumference D6 centered on the axis X and passing through the radially internal ends of the buckets.

Preferably:
Dext_Cl≤Dext_Go≤Dext_Sa, and
Dint_Sa≤Dint_Go≤Dint_Cl.

In a variant not shown, the scoops are formed in one-part with the planet carrier or a portion of the planet carrier, and for example with one of these rings A1, A2.

The operation of the assembly 230 is shown schematically in FIGS. 6 and 7.

On start-up and during operation, the assembly 230 rotates about the axis X and its bottom portion is immersed in the oil H1 present in the reducer 106, 206 or arranged all around the reducer to form a ring H2 in the enclosure. The scoops 250 force the oil to move (arrows T) and direct this oil in a predetermined direction, for example towards the gears to be lubricated. The mesh to be lubricated is, for example, that between the planet gears and the stationary ring gear in a Wolfrom type reducer.

Alternatively, the scoops 250 may simply collect oil at the bottom portion and feed it to the top portion. Once at the top, the oil may drip onto elements requiring a lubrication.

When there is a single scoop 250 between two adjacent planet gears 232, their concavities 256 are oriented according to the direction of rotation of the assembly 230 so that the oil may be recovered and displaced by these concavities.

In the variant of embodiment shown in FIG. 8, the reducer 106 is of the epicyclic type and comprises a single ring gear 109. Each scoop 250 is positioned so that its bucket or buckets 252, 254 is offset axially from the ring gear 109 to scoop oil next to the ring gear 109. In this case, Dext-Go may be greater than or equal to the internal diameter of the ring gear 109.

In the variant embodiment shown in FIG. 9, the reducer 206 is of the Wolfrom type and comprises two ring gears, a movable ring gear 209a and a stationary ring gear 209b. Each scoop 250 is positioned so that its bucket or buckets 252, 254 is axially offset from the ring gear 209b and radially aligned with the ring gear 209a. The scoops 250 are configured to scoop oil from the ring gear 209a. In this case, Dext-Go may be greater than or equal to the internal diameter of the ring gear 209b and is less than the internal diameter of the ring gear 209a.

In FIGS. 8 and 9, the references 260 refer to the aforementioned means of attaching the plates 258 of the scoops 250 to the planet carrier 234.

FIG. 10 shows a drive system 310 for driving at least one wheel 312 of an aircraft landing gear 314.

The wheel 312 comprises a rim 316 with an axis of rotation X. Conventionally, this rim 316 is generally tubular or disc-shaped and carries a tire 318 on its periphery.

The system 310 comprises an electric motor 320 and a mechanical transmission system 322 between a shaft of the motor 320 and the rim 316 of the wheel 312.

In the example shown, the motor 320 and the system 322 each have a generally annular shape and are centered on the axis X. They are arranged next to each other and the system 322 is installed between the motor 320 and the rim 316. A portion of the system 322, or even a portion of the motor 320, may be housed in the rim 16 to reduce the overall dimension of the system 310. The motor 320 and the system 322 may be protected by an outer cylindrical cowl 326 projecting from one side of the rim 316 or of the tire 318.

The mechanical transmission system 322 comprises a mechanical reducer 328 similar to the reducer 106, 206 described above and including an assembly 230 within the meaning of the invention.

1. An assembly comprising planet gears and a planet carrier for a mechanical splash-lubricated reducer, in particular for an aircraft, this assembly having an annular shape about a longitudinal axis,
the planet gears being evenly spaced around said axis and each comprising two cylindrical longitudinal ends,
the planet carrier having an annular shape about said axis and comprising housings for receiving the planet gears, these housings being evenly distributed about said axis and each being axially delimited by two walls extending respectively in two planes perpendicular to said axis, and two lateral bulkheads extending between the walls these walls, comprising orifices for mounting said longitudinal ends of the planet gears,
wherein the assembly further comprises oil scoops which are secured to the planet carrier and which are evenly distributed around said axis and interposed between the planet gears, each of these scoops comprising at least one curved bucket, the concavity of which extends partly around one of the planet gears and is separated from this planet gear by one of said bulkheads.

2. The assembly according to claim 1, wherein each of the scoops comprises two curved buckets whose concavities are oriented in opposite directions to extend respectively around the planet gears between which the scoop is mounted.

3. The assembly according to claim 2, wherein the two buckets of each of the scoops are connected to each other by a plate for attachment to the planet carrier.

4. The assembly according to claim 1, wherein each of the scoops is formed in one-part.

5. The assembly according to claim 1, wherein the bucket, and the planet gear around which the concavity of the bucket extends, are located at a circumferential distance from each other which is greater than or equal to half a maximum radius of the planet gear.

6. The assembly according to any of the preceding claims, wherein the or each bucket has an axial dimension which is less than an axial dimension of said bulkheads.

7. The assembly according to claim 1, wherein:
Dext_Cl≤Dext_Go≤Dext_Sa, and
Dint_Sa≤Dint_Go≤Dint_Cl,
wherein:
Dext_Cl is the diameter of a circumference (C3) centered on said axis and passing through radially external ends of said bulkheads,
Dext_Go is the diameter of a circumference (C5) centered on said axis and passing through radially external ends of said buckets,
Dext_Sa is the maximum diameter of a circumference (C1) centered on said axis and passing through the planet gears,
Dint_Sa is the minimum diameter of a circumference (C2) centered on said axis and passing through the planet gears,
Dint_Go is the diameter of a circumference (C6) centered on said axis and passing through radially internal ends of said buckets, and
Dint_Cl is the diameter of a circumference (C4) centered on said axis and passing through radially internal ends of said bulkheads.

8. The assembly according to claim 1, wherein each of the scoops is attached by screws or bolts to the planet carrier, these screws or bolts also being used to attach two rings of the planet carrier respectively forming said walls of said housings.

9. The assembly according to claim 1, wherein said bulkheads are formed in one-part with one of the walls of the planet carrier.

10. The assembly according to claim 1, wherein the scoops are formed in one-part with the planet carrier or a portion of the planet carrier.

11. A mechanical splash-lubricated reducer, in particular for an aircraft, the reducer comprising:
a sun gear which is movable in rotation about a longitudinal axis,
at least one ring gear mounted around the sun gear and said longitudinal axis, and
an assembly according to claim 1 which is movable in rotation about said longitudinal axis, the planet gears of this assembly being mounted between the sun gear and the ring gear and meshed with the sun gear and the ring gear, these planet gears having axes of rotation parallel to said axis, and
a sealed enclosure wherein the sun gear, the first ring gear and said assembly (203) are located, this enclosure being configured to contain oil intended to be scooped by the oil scoops of said assembly.

12. The reducer as claimed in claim 11, wherein the planet gears are double-stage and comprise a first stage meshed with a first ring gear which is movable about said longitudinal axis and the sun gear, and a second stage meshed with a second ring gear which is stationary relative to said longitudinal axis.

13. The reducer according to claim 11, wherein the or each bucket of each of the scoops is offset axially from the ring gear in order to scoop oil next to the ring gear, or is axially offset from the stationary ring gear ) and radially aligned with the mobile ring gear in order to scoop oil at the level of this mobile ring gear.

14. A turbomachine, in particular for an aircraft, comprising at least one assembly according to claim 1 or a mechanical reducer, in particular for an aircraft, the reducer comprising:
a sun gear which is movable in rotation about a longitudinal axis,
at least one ring gear mounted around the sun gear and said longitudinal axis, and
the at least one assembly being movable in rotation about said longitudinal axis, the planet gears of this assembly being mounted between the sun gear and the ring gear and meshed with the sun gear and the ring gear, these planet gears having axes of rotation parallel to said axis, and
a sealed enclosure wherein the sun gear, the first ring gear and said assembly are located, this enclosure being configured to contain oil intended to be scooped by the oil scoops of said assembly.

15. A drive system for driving a wheel of a landing gear, in particular for an aircraft, comprising at least one assembly according to claim 1 or a mechanical reducer in particular for an aircraft, the reducer comprising:
a sun gear which is movable in rotation about a longitudinal axis,
at least one ring gear mounted around the sun gear and said longitudinal axis, and
the at least one assembly being movable in rotation about said longitudinal axis, the planet gears of this assembly being mounted between the sun gear and the ring gear and meshed with the sun gear and the ring gear, these planet gears having axes of rotation parallel to said axis, and
a sealed enclosure wherein the sun gear, the first ring gear and said assembly are located, this enclosure being configured to contain oil intended to be scooped by the oil scoops of said assembly.
